(19) United States
(12) Patent Application Publication
(10) Pub. No.: US 2008/0211327 A1
(43) Pub. Date: Sep. 4, 2008

(54) Battery Pack And Electric Hand-Held Power Tool

(76) Inventors: Andreas Schlegel, Leinfelden-Echterdingen (DE); Jochen Krauter, Hildrizhausen (DE); Holger Frank, Pfullingen (DE)

Correspondence Address: Striker, Striker & Stenby, 103 East Neck Road, Huntington, NY, 11743, US

(21) Appl. No.: 11/578,015

(22) PCT Filed: Jun. 20, 2005
(86) PCT No.: PCT/EP05/52851

§ 371 Date: Oct. 10, 2006

(30) Foreign Application Priority Data
Jul. 28, 2004 (DE) 10 2004 036 588.1

(51) Int. Cl. H02K 7/14; H01M 10/36

(52) U.S. Cl. 310/50; 429/122

(57) ABSTRACT

The present invention provides a replaceable battery pack for an electric hand-held power tool (10), which is designed to be attached to the outside of an end face of a handle region (16) of the electric hand-held power tool (10), with a contacting means (30), via which an electrical contact with the electric hand-held power tool (10) can be established, and with a fastening means for detachable attachment with the electric hand-held power tool (10), the battery pack being designed essentially to be attached in and/or against a working direction (19) of the electric hand-held power tool (10), and the fastening means being designed as a retaining means for accommodating a locking means (40) of the electric hand-held power tool (10).

### RELATED ART

A replaceable battery pack is used as a power source for a cordless electric hand-held power tool, such as a cordless drill or a cordless rotary hammer. A battery pack of this type includes rechargeable batteries as the batteries. The electrical contacting between the battery pack and the electric hand-held power tool takes place via suitable contacting means, which, in the installed state of the battery pack, establish the necessary electrical contact with the electric hand-held power tool. Once the power from the battery pack has been exhausted via operation of the electric hand-held power tool, the battery pack is removed and recharged, e.g., via the household electrical system, for re-use. It is common knowledge that the battery pack and the electric hand-held power tool are designed such that the battery pack can be inserted and removed easily and quickly.

A battery pack is generally known which—in a common working position of the electric hand-held power tool, with a working direction pointing toward the front as viewed by an operator—can be attached at the bottom, to the end face of the handle region of the electric hand-held power tool. An electric hand-held power tool is also known which includes a battery pack receiving compartment which, in a common working position, is open vertically downward and allows the battery pack to be inserted and removed in the vertical direction. Furthermore, a battery pack is known which is designed to be attached to the outside of an end face of a handle region, behind the handle as viewed in the working direction. To replace the battery pack, the holding hand remains in the handle region of the electric hand-held power tool, while the free hand moves on an actuating element located on the battery pack. The attachment of the battery pack is thereby released. The battery pack drops into the free hand, or it can be removed with the free hand.

### ADVANTAGES OF THE INVENTION

A replaceable battery pack for an electric hand-held power tool is provided, which is designed to be attached to the outside of an end face of a handle region of the electric hand-held power tool, with a contacting means, via which an electrical contact with the electric hand-held power tool can be established, and with a fastening means for detachable attachment with the electric hand-held power tool, the battery pack being designed essentially to be attached in and/or against a working direction of the electric hand-held power tool, and the fastening means being designed as a retaining means for accommodating a locking means of the electric hand-held power tool. The wording “essentially in and/or against a working direction” is intended to mean that solutions are also included with which the battery pack is designed to be attached at an angle of up to 40°, and particularly advantageously less than 20°, relative to the working direction. In addition, the wording “locking means” is intended to mean, in particular, means which include at least one movable, preferably movably supported, element, e.g., an element which is movable via elastic deformation, or an element which is supported such that it is displaceable and/or slidable, etc. The wording “retaining means” is intended to mean, in particular, means which include at least one fixed element, e.g., a projection and/or a recess, etc.

The battery pack described is designed to be attached to the outside of an end face of the handle region. This can take place via a sliding, clamping, and/or screw-in retaining means. The battery pack can also be slid into a battery pack receiving compartment. The fact that the battery pack is located on the outside of the end face makes it possible for nearly any predefined weight distribution or shape of the hand-held power tool to be attained. An advantageous variability of a housing of an electric hand-held power tool and of the handle region in particular can be attained. Furthermore, the battery pack can be designed advantageously free of an actuating element for releasing the attachment with the electric hand-held power tool, and particularly comfortable installation and removal of the battery pack can be attained.

The battery pack described can be manufactured more cost-effectively than the related art, since it can be designed with fewer components. The costs of the entire system are reduced further by eliminating the locking means and/or the actuating means from a replacement part and moving them to the electric hand-held power tool.

At least one and preferably several pockets are provided as retaining means. As a result of this design, a large support surface and a secure locking of the battery pack with the electric hand-held power tool are easily attained. The pockets can also be designed to serve simultaneously as ventilation slits, which enable the rechargeable batteries to be cooled while the battery pack is being recharged in a charging device.

The contacting means are advantageously located in front of the fastening means, as viewed in the direction of insertion. A front end of the battery pack, which is insertable in the electric hand-held power tool, can then be easily and reliably connected via the fastening means with a battery pack fastening means of the electric hand-held power tool. This design also makes possible a space-saving design of the battery pack fastening means in the electric hand-held power tool.

The invention also provides an electric hand-held power tool with a battery pack receptacle, a battery pack contacting means for electrical contacting, and a battery pack fastening means for the detachable attachment of a battery pack, the battery pack receptacle being located on the outside of an end face of a handle region, and the battery pack fastening means being designed as a locking means, which, in their holding position, engage in a retaining means of the battery pack.

The present invention makes possible an ergonomic design of the electric hand-held power tool and particularly comfortable installation and removal. By locating the battery pack receptacle on the outside of the end face, a desired weight distribution in the device can be attained, independently of the type of electric hand-held power tool. The battery pack receptacle can be designed to establish a sliding, clamping, and/or screw connection.

Due to the fact that the battery pack fastening means are designed as a locking means which, in their holding position, engage in a retaining means of the battery pack, a particularly cost-effective design can be attained, because a technically more complex—due particularly to the fact that it is movable—part of a fastening means can be eliminated from the battery pack, which is a replacement part, and can be included on the electric hand-held power tool. This design is also less susceptible to interference, because it is advantageously possible to manufacture the entire fastening means—which are composed of the retaining means of the battery pack and a locking means of the electric hand-held power tool—essentially out of only two parts, i.e., a lock and a spring. The engagement of the locking means in the retaining means can take place, e.g., via a mechanical preload of a coiled spring. When the battery pack is inserted, the locking means are initially deflected mechanically against the spring force, then they snap into the retaining position. To release the attachment, the locking means must be moved against the preload. Any other type of preload, e.g., mechanical or electrical, is also feasible, of course.

The battery pack receptacle is advantageously designed as a battery pack receiving compartment, which can accommodate at least part of the battery pack. The battery pack is thereby protected against contamination. It is also made less likely that the attachment will accidentally release and cause the battery pack to drop out. Working safety is increased.

Advantageously, in the common working position, the battery pack receiving compartment is oriented essentially horizontally. In this context, a “common working position” is intended to mean, in particular, a working position in which the working direction extends at least substantially, i.e., ±20° and preferably ±10°, parallel to a horizontal plane.

Due to the orientation of the battery pack receiving compartment, which is essentially horizontal in the common working position, the battery pack does not slide out of the battery pack receptacle on its own, even when the battery pack is accidentally released. With most applications of the electric hand-held power tool, the weight of the battery pack does not rest on the attachment. In the common working position of the electric hand-held power tool, it is possible to insert and remove the battery pack in the essentially horizontal direction.

In a further advantageous design, the battery pack receiving compartment is open toward the front. In this case, the “front” is intended to mean in the direction of the working direction. The working direction is the direction in which the force exerted with the electric hand-held power tool points. With a drill, this is the direction in which the drill advances, for example. An orientation of this type makes ergonomic operation—in terms of replacing the battery pack—of the electric hand-held power tool possible.

The contacting means are advantageously located on the rear end of the battery pack receptacle, as viewed in the direction of insertion. The front end of the battery pack, which is insertable in the electric hand-held power tool, can then be easily and reliably connected via the fastening means with a battery pack fastening means of the electric hand-held power tool. This design also makes possible a space-saving design of the battery pack fastening means in the electric hand-held power tool. It is advantageous when the battery pack contacting means are located between a front end and a rear end of the battery pack receptacle, as viewed in the direction of insertion.

In a further advantageous embodiment of the present invention, the locking means include a guided sliding lock. This mechanical design enables secure, wear-resistant, and comfortable motion or actuation of the locking means. The guidance of the sliding lock can be easily realized via suitable guidance means in both shells of the housing of the electric hand-held power tool.

To ergonomically actuate the sliding lock to release the connection of the locking means with the battery pack, an actuating element guided on the outside of the housing is attached to the sliding lock, via which the sliding lock can be released from its holding position. A design of this type makes one-hand operation possible. While the holding hand remains in the handle region of the electric hand-held power tool, the free hand actuates the sliding lock using the outwardly guided actuating element, by way of which the locking means release the battery pack. The battery pack can then be removed with the free hand in the horizontal direction.

To this end, the actuating element on an underside is advantageously guided on the outside of the housing, by way of which an advantageous, symmetrical design can be advantageously attained. With regard for the handle region, it is ergonomically beneficial to locate it in front of the battery pack receiving compartment, as viewed in the working direction. This design can be deviated from, however, e.g., in the case of pistol-shaped power tools and, in particular, hand-held power tools which are not designed in the shape of a pistol, e.g., hedge trimmers, angle grinders or polishers, etc.

### DRAWING

Further advantages result from the description of the drawing, below. An exemplary embodiment of the present invention is shown in the drawing. The drawing, the description and the claims contain numerous features in combination. One skilled in the art will also advantageously consider the features individually and combine them to form further reasonable combinations.

FIG. 1 shows, in a semi-exposed view, a cordless rotary hammer with a horizontally oriented battery pack, and

FIG. 2 shows, in an exploded view, a battery pack fastening means with a sliding lock, and the battery pack, which is detachably connectable via the sliding lock.

### DETAILED DESCRIPTION OF THE EXEMPLARY EMBODIMENTS

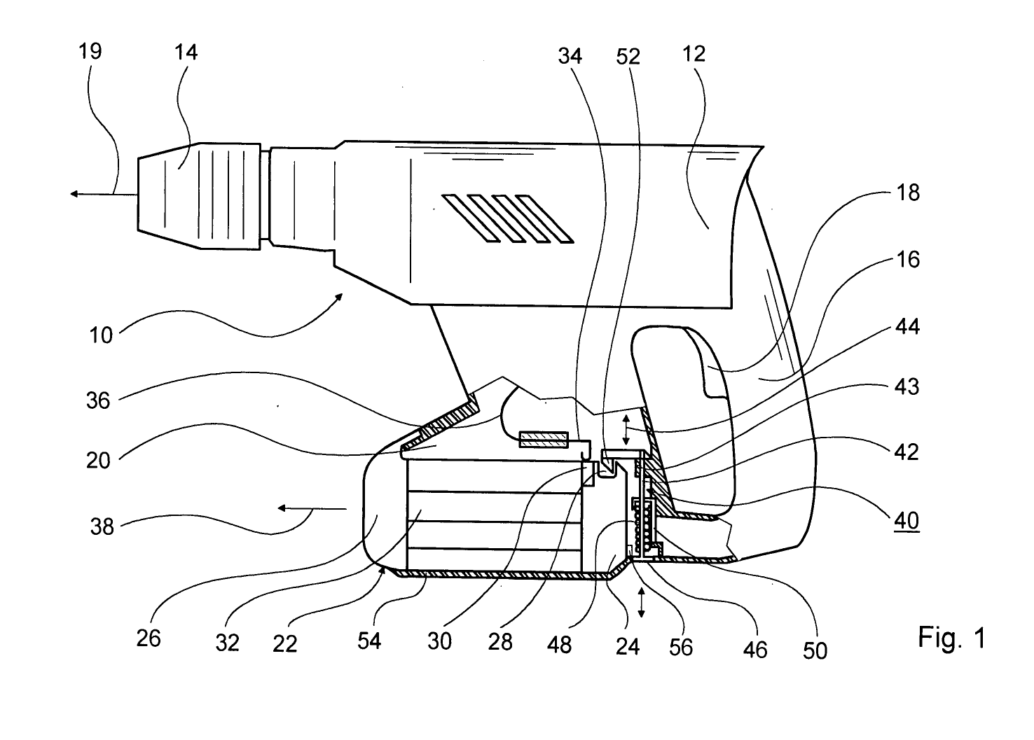

FIG. 1 shows a cordless rotary hammer 10 designed as an electric hand-held power tool. Rotary hammer 10 includes a drive part 12, which drives a drill chuck 14, and a handle region 16 with a switch 18 located there for actuating rotary hammer 10. In a common working position, rotary hammer 10 with working part 12 located on the top is held such that its working direction 19—that is, the direction in which the exerted force points—faces forward, as viewed by an operator. Working direction 19 extends parallel to a horizontal plane.

Underneath working part 12, rotary hammer 10 includes a battery pack receiving compartment 20—which serves as a battery pack receptacle and extends essentially horizontally in the common working position—with a base part 54, into which a battery pack 22 is inserted with a front end 24 and a rear end 26 against the working direction 19, as shown clearly in the semi-exposed view. Base part 54 of battery pack receiving compartment 20 could also be designed shorter in working direction 19, so that battery pack 22 is supported at least horizontally downward only at its front end 24, which faces shoulder 18, e.g., via an indicated projection 56 thereon, and at its rear end 26, which faces away from shoulder 18, on a housing part in the orientation shown, by way of which the amount of material used could be reduced.

Front end 24 includes three—not entirely visible—integrally-formed pockets 28, which are provided to enable attachment with rotary hammer 10. Contacting means 30 designed as a metallic rail are located behind pockets 28 and are electrically connected with rechargeable batteries 32 located in battery pack 22. In the installed state, contacting means 30 are electrically contacted with the drive of rotary hammer 10 via battery pack contacting means 34 designed as a clip contact, and via a connecting cable 36 connected thereto. In the direction of insertion, which extends opposite to working direction 19, battery pack contacting means 34 are located between the front end and the rear end of battery pack receiving compartment 20, which serves as the battery pack receptacle. The shape of battery pack 22 is adapted to a housing of rotary hammer 10.

As viewed in working direction 19, battery pack receiving compartment 20 is located behind handle region 16 of rotary hammer 10 and is open toward the front. Once it has been released, battery pack 22 can be removed from battery pack receiving compartment 20 toward the front in the horizontal direction—in the common working position—as indicated by an arrow 38.

To attach battery pack 22 to rotary hammer 10, locking means 40 are located directly in front of handle region 16 and on the inner end of battery pack receiving compartment 20 in the housing, as viewed in the direction of insertion of battery pack 22. Locking means 40 include a sliding lock 42, which is slidable in guide elements 43 formed in and extending out of the housing. Sliding lock 42 includes an actuating element 46 as an extension, and, in lower handle region 16, is guided out of the housing on an underside of the housing. A compression spring 48 bears against sliding lock 42, which bears against a support frame 50, which is also formed in the housing. In this manner, compression spring 48 exerts a force on sliding lock 42, which is oriented downward and out of the housing.

When battery pack 22 is inserted into battery pack receiving compartment 20 of rotary hammer 10, it first slides upward—as shown in the illustration—due to the oblique angle of pockets 28 and the engaging part of sliding lock 42, against the force of compression spring 48. When battery pack 22 is slid further, the engaging part of sliding lock 42 ultimately engages in pockets 28 of front end 24 of battery pack 22 and establishes a secure connection of battery pack 22 with rotary hammer 10. Pressing actuating element 46 causes sliding lock 42 to slide upward, and the connection with battery pack 22 is released. Battery pack 22 can then be removed with the free hand, while the holding hand remains on handle region 16 of rotary hammer 10.

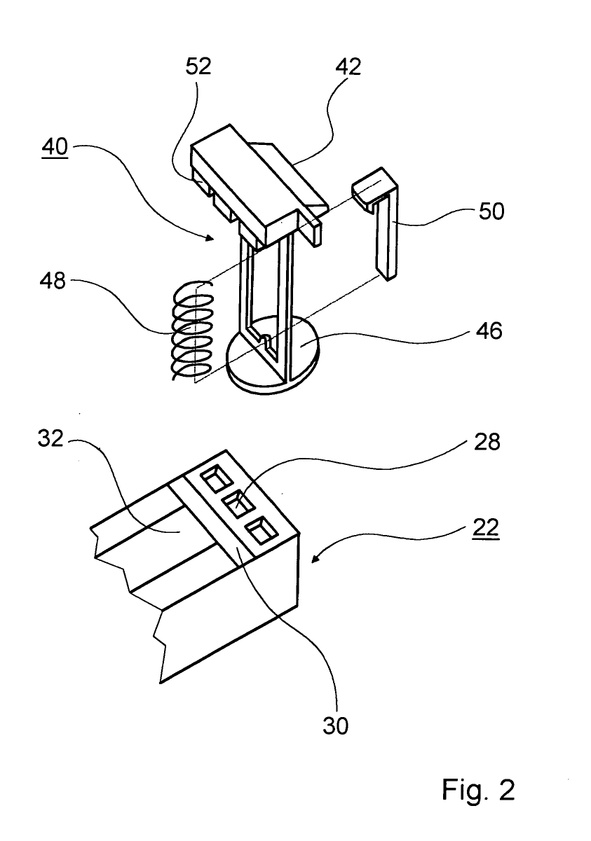

In FIG. 2, locking means 40 shown in FIG. 1 are shown together with battery pack 22 in an exploded view. Sliding lock 42 and compression spring 48, which bears against support frame 50, are shown clearly. The engaging part of sliding lock 42 includes three knobs 52, which engage in the three integrally formed pockets 28 on the upper edge after battery pack 22 is inserted, thereby establishing a secure, detachable connection. Contacting means 30, which are designed as a metallic rail, and individual rechargeable batteries 32 are shown clearly on battery pack 22.

What is claimed is:

1. A replaceable battery pack for an electric hand-held power tool (10), which is designed to be attached to the outside of an end face of a handle region (16) of the electric hand-held power tool (10), with a contacting means (30), via which an electrical contact with the electric hand-held power tool (10) can be established, and with a fastening means for detachable attachment with the electric hand-held power tool (10), the battery pack being designed essentially to be attached in and/or against a working direction (19) of the electric hand-held power tool (10), and the fastening means being designed as a retaining means for accommodating a locking means (40) of the electric hand-held power tool (10).

2. The battery pack as recited in claim 1,
wherein
at least one pocket (28) is provided as the retaining means.

3. The battery pack as recited in claim 1,
wherein
the contacting means (30) are located in front of the fastening means, as viewed in the direction of insertion.

4. The electric hand-held power tool (10) with a battery pack receptacle, a battery pack contacting means (34) for electrical contacting, and a battery pack fastening means for detachably attaching a battery pack (22), the battery pack receptacle being located on the outside of an end face of a handle region (16), and the battery pack fastening means being designed as a locking means (40), which, in their holding position, engage in a retaining means of the battery pack (22).

5. The electric hand-held power tool (10) as recited in claim 4,
wherein
the battery pack receptacle is designed as a battery pack receiving compartment (20) which, in the common working position, is oriented essentially horizontally.

6. The electric hand-held power tool (10) as recited in claim 5,
wherein
the battery pack receiving compartment (20) is open toward the front.

7. The electric hand-held power tool (10) as recited in claim 4,
wherein
the fastening means are located on the rear end of the battery pack receptacle, as viewed in the direction of insertion.

8. The electric hand-held power tool (10) as recited in claim 4,
wherein
the battery pack contacting means (34) are located between a front end and a rear end of the battery pack receptacle, as viewed in the direction of insertion.

9. The electric hand-held power tool (10) as recited in claim 4,
wherein
the locking means (40) include a guided sliding lock (42).

10. The electric hand-held power tool (10) as recited in claim 9,
wherein
an actuating element (46) guided on an outer housing side of an electric hand-held power tool (10) is attached to the sliding lock (42), via which the sliding lock (42) can be released from its holding position.

11. The electric hand-held power tool (10) as recited in claim 10,
wherein
the actuating element (46) is guided on an underside of the housing of the electric hand-held power tool on the outside of the housing.
